(19) United States
(12) Patent Application Publication
(10) Pub. No.: US 2007/0019210 A1
(43) Pub. Date: Jan. 25, 2007

(54) Time-delayed source and interferometric measurement of windows and domes

(76) Inventors: William P. Kuhn, Tucson, AZ (US); Matthew Dubin, Tucson, AZ (US)

Correspondence Address: David W. Collins;Intellectual Property Law, Suite 100, 512 E. Whitehouse Canyon Road, Green Valley, AZ, 85614, US

(21) Appl. No.: 11/488,941

(22) Filed: Jul. 17, 2006

Related U.S. Application Data
(60) Provisional application No. 60/700,987, filed on Jul. 19, 2005.

(51) Int. Cl. G01B 11/02

(52) U.S. Cl. 356/512; 356/497

(57) ABSTRACT

An interferometer comprises a time-delayed source, light emitted from the time-delayed source, a unit under test where the unit under test has a first surface and a second surface, and a detector. The light emitted from the time-delayed source has a delay length. A first portion of the light is reflected off the first surface of the unit under test and a second portion of the light is reflected off of the second surface of the unit under test. A portion of the two reflected portions of light are incident on the detector where the light coherently adds, which forms an interference pattern that is detected by the detector.

### CROSS REFERENCE TO RELATED APPLICATIONS

The present application claims priority from provisional application Ser. No. 60/700,987, filed Jul. 19, 2005.

The present application is also related to application Ser. No. ______, filed con-currently herewith, entitled “Interferometer for Measurement of Dome Like Objects”, by the present inventors.

### FIELD OF THE INVENTION

The present application is directed to interferometers, and, more particularly, to mechanisms for suppressing measurement errors due to reflections other than from surfaces of interest.

### BACKGROUND OF THE INVENTION

Fabrication of an optical component depends upon the ability to measure the optical properties of the component. An essential characteristic of an optical component is the quality of a wavefront after transmission through or reflection from the component. If the optical component is a mirror, then it is the reflected wavefront or surface figure of the component that is of interest. If the optical component is a transmissive element, then it is the transmitted wavefront that is of primary interest. An optical dome is a transmissive optical element whose angular extent is large and whose surfaces have historically been concentric, or nearly so, in the ideal case. Deterministic fabrication techniques for domes make it necessary to measure with greater accuracy and density than has been historically possible. Additionally, the use of domes having a more aerodynamic shape than a hemisphere is limited because of the difficulty in measuring the transmitted wavefront of such domes. The present invention is directed towards the measurement of the transmitted wavefront of optical domes and windows or similar optical components.

Historically, the concentricity of the two surfaces of a dome have been tested by using a point source of monochromatic light placed at the center-of-curvatures of the two surfaces and then looking at an interference pattern produced by the light reflected from each of the two surfaces of the dome as illustrated in FIG. 1; see Malacara, Daniel, (ed.), Optical Shop Testing, Second Edition, John Wiley & Sons, Inc., 1992. This test configuration is a variant of a Fizeau interferometer where interference between light reflected from the surfaces of the test object is obtained without a separate reference surface. The interference pattern is observed by placing one's eye or a camera and lens in the vicinity of the focus of the reflected light so as to capture the light while focusing on the dome. A perfect dome of two concentric surfaces would produce a null interference pattern while wedge between the two surfaces produces tilt fringes and a radius error produces circular fringes in the interference pattern.

Deterministic fabrication techniques are limited by the quality of the measured data. High-quality interferometric measurements are often performed using phase-shifting methods where the phase of one wavefront is modulated relative to the other wavefront and the wavefront phase is calculated from a series of phase-shifted images in any of a variety of known methods. However, if both surfaces are rigidly attached to each other, then it is not possible to move one surface relative to the other in order to modulate the relative phase of the two wavefronts. If a monochromatic source whose wavelength can be varied is used, then varying the wavelength of the source will modulate the relative phase of the two wavefronts.

In order to obtain an interference pattern using the configuration of FIG. 1, it is necessary to use a source with a coherence length greater than the optical path length difference between the two reflected wavefronts that is twice the product of the dome thickness and index of refraction. Unfortunately, the light reflected by the outer dome surface will produce a reflection from the inner dome surface, a portion of which will reflect from the outer surface producing a ghost reflection at the detector. Ghost reflections that are even partially coherent with the desired reflections will affect the interference pattern that is detected and limit the accuracy of the measurements when using algorithms based upon two-beam interference, which is true for most phase shifting algorithms. The most common source that is wave-length tunable is an external-cavity laser-diode, which has substantial temporal coherence leading to ghost images that will limit measurement accuracy.

Zygo Corporation has developed a general purpose device and method for using a Fizeau interferometer to measure multiple interference cavities which is embodied in their Verifire model interferometer. One of the applications of the Verifire technology is the measurement of the front surface, back surface and optical thickness variation of a parallel window in a single setup. The Zygo instrument provides the means to measure an optical surface or transmitted wavefront in the presence of multiple reflections that are coherent (i.e. the multiple reflections interfere). However, the Zygo instrument incorporates a reference surface and when used to measure a dome it is still necessary to align the instrument (i.e. reference surface) to the dome with high precision to obtain the desired interference pattern produced by a combination of reflections from multiple surfaces.

What is required therefore is a device and method for measurement of the transmitted wavefront of a dome or dome like optic whose alignment tolerances are modest and measurement errors due to multiple reflections are suppressed.

### SUMMARY OF THE INVENTION

An interferometer is provided that comprises a time-delayed source, light emitted from the time-delayed source, a unit under test where the unit under test has a first surface and a second surface, and a detector. Light emitted from the time-delayed source has a delay length. A first portion of the light is reflected off the first surface of the unit under test and a second portion of the light is reflected off of the second surface of the unit under test. A portion of the two reflected portions of light are incident on the detector where the light coherently adds which forms an interference pattern that is detected by the detector.

### BRIEF DESCRIPTION OF THE DRAWINGS

The above and other features of the invention including various novel details of construction and combination of parts will now be more particularly described with reference to the accompanying drawings and pointed out in the claims. It will be understood that the particular interferometer apparatus embodying the invention is shown by way of illustration only and not as a limitation of the invention. The principles and features of this invention may be employed in varied and numerous embodiments without departing from the scope of the invention,

FIG. 1 is a diagram of a prior art setup for testing the concentricity of a spherical shell.

FIG. 2 is a diagram of a prior art setup for measuring a plane parallel plate.

FIG. 3 is a diagram of a section of the unit under test that demonstrates the reflections of interest.

FIG. 4 is a diagram of a time-delayed source.

FIG. 5 is a diagram of an embodiment of the interferometer system including optional scanning mechanisms and optional wavefront matching optics

FIG. 6 is a graphical representation of the coherence length of the time-delayed source.

FIG. 7 is a diagram of an example conformal dome.

### DETAILED DESCRIPTION OF PREFERRED EMBODIMENTS

An interferometer is described that is capable of measuring the transmitted wavefront of a substantial portion of a dome like optic without the use of a reference surface separate from the unit under test (UUT) while also suppressing measurement errors due to reflections other than the first reflection from each of the two surfaces of interest (i.e., the primary reflections of interest). Suppression of measurement error is accomplished through the use of a short coherence length source, such as a superluminescent diode, in conjunction with a time-delayed source generator. The combination of a short coherence length source and time-delayed source generator is referred to as a time-delayed source (TDS).

The TDS includes a source with a coherence length shorter than the optical path length between the primary reflections of interest from the UUT. The output of the short coherence length source is split into two parts of similar power each following a different path. The two paths have a difference in length that substantially matches the path length difference between the primary reflections of interest. The light from the two paths in the TDS is combined and then used as the source for an interferometric test of the transmitted wavefront of a dome-like optic. The maximum fringe visibility possible is one if there is no stray light and the two interfering beams have equal power. For the invention described herein, the maximum fringe visibility possible is one-half, since both surfaces of the UUT reflect light from both paths in the TDS. A fringe visibility of close to one-half is more than adequate to obtain good data using phase-shifting algorithms that are known. An additional benefit of the TDS is that modifying the time-delay between the two paths within the TDS modulates the phase of the interference pattern making it possible to use phase shifting algorithms known in the art while suppressing errors due to undesired reflections.

The present invention has significant benefits for the measurement of a UUT with a large numerical aperture. One approach to measuring a UUT with a large numerical aperture is to use a wavefront matching optic such as the reflective optic described in the concurrently-filed patent application referenced above. The reduced alignment sensitivity reduces the difficulty and measurement errors resulting from the use of a wavefront matching optic with a large numerical aperture. A second approach is to measure only a small portion or sub-aperture of the UUT at a time. A scanning mechanism is used that moves either the instrument, UUT or both to change the relative position of the UUT and instrument so that a second, possibly overlapping sub-aperture is measured. The process is repeated until measurements over the desired portion of the UUT are obtained. The multiple measurements are then assembled (“stitched”) into a single measurement of UUT. The performance requirements of the scanning mechanism are reduced due to the reduced alignment sensitivity of the present invention.

There are additional benefits to the present invention in regards to sub-aperture measurements and stitching of the data. When stitching data that is measured against a reference surface it is necessary to account very accurately for the reference surface, either by calibrating it directly via measurement or indirectly by incorporating the reference surface into the equations solved for stitching of the data. Even if the reference surface is well calibrated, stitching of such data requires the use of compensators for all six translations and rotations of the individual data sets relative to each other. Since the present invention does not have a reference surface, stitching is simpler than if the data is acquired with an instrument having a reference surface. Mapping and retrace errors may limit the size of a sub-aperture that can be measured for any given UUT.

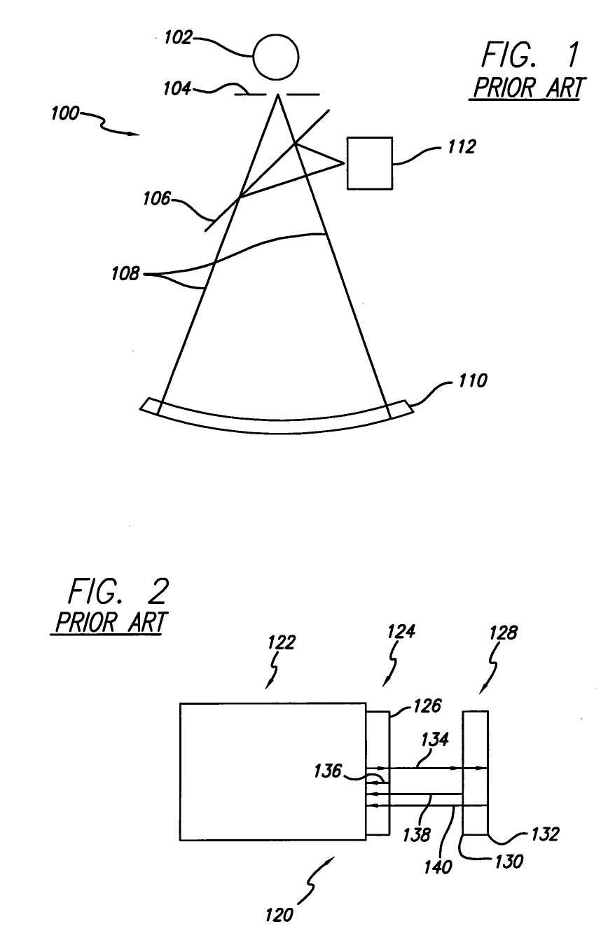

FIG. 1 is a diagram of a prior art configuration 100 for testing the concentricity of the surfaces of a spherical shell 110 (see Malacara, page 25). A portion of the light from a mono-chromatic source 102 is directed through a pinhole 104 located proximate to the center of curvature of the two surfaces of spherical shell 110. Rays 108 originating at pinhole 104 are directed towards beam splitter 106. The light transmitted through the beam splitter 106 is directed towards spherical shell 110, a portion of which is reflected by the each surface of spherical shell 110. A portion of the reflected light from each surface is reflected by beam splitter 106 and directed towards an observer's eye 112. If the observer's eye is focused on the spherical shell 110 and monochromatic source 102 has sufficient coherence length, then the observer will be able to see an interference pattern resulting from deviations of the dome from concentricity. Straight fringes indicate wedge, concentric fringes indicate an axial displacement of the centers of curvatures of the two surfaces of spherical shell 110. The interference pattern is therefore a measure of the transmitted wavefront error of the spherical shell 110.

The prior art configuration 100 in FIG. 1 permits analysis of the transmitted wavefront errors by fringe analysis. It is even possible to perform phase shifting analysis if a suitable source is found for wavelength shifting approaches. However, the significant coherence length implicitly present in a monochromatic source 102 results in limitations on the accuracy of the measurements due ghost reflections from the dome, which are inherent in a test of a spherical shell 110.

FIG. 2 is a diagram of a prior art configuration 120 for testing of a plane parallel plate 128. Prior art configuration 120 is different than the historical method of testing a plane parallel plate performed using a Fizeau interferometer 122 and a return flat. In prior art configuration 120 a transmission flat 124 is placed on the front of interferometer 122. A plane parallel plate 128 is placed in front of the interferometer 122 so that reflections from reference surface 126, first surface 130 and second surface 132 of plane parallel plate 128 are aligned and coherently add to form an interference pattern on the detector in interferometer 122.

Zygo Corporation has developed algorithms to process a large number of interferograms taken using prior art configuration 120 so as to determine the errors on first surface 130, second surface 132 and optical thickness variation (i.e. transmitted wavefront) of a plane parallel plate. The Zygo instrument is capable of measuring the transmitted wavefront of plane parallel windows as well as dome like optics with the use of appropriate wavefront matching optics (i.e. reference optics). However, the reference surface of the Fizeau interferometer 120 must be well aligned to the unit under test. In addition, measurements made using Fizeau interferometer 120 are sensitive to the environment.

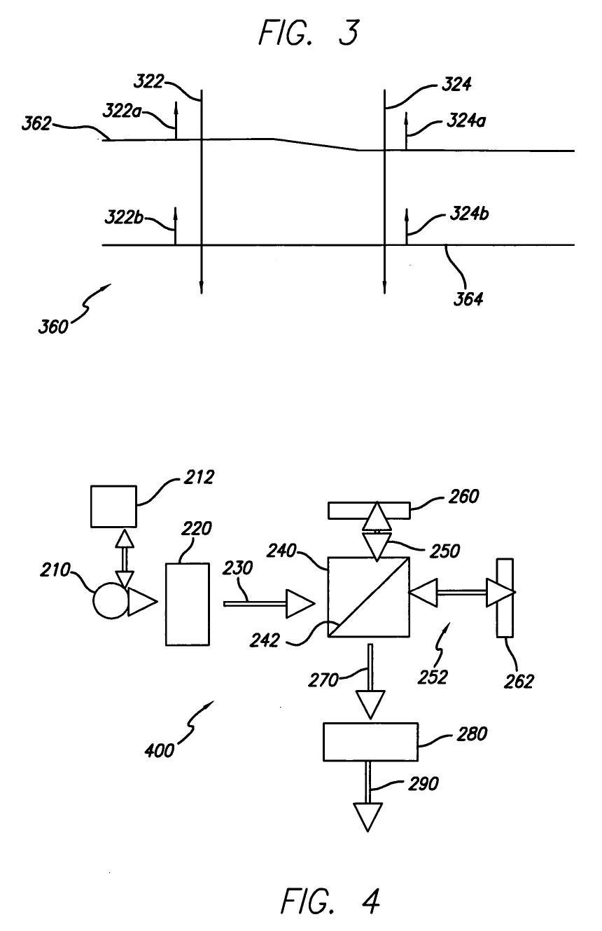

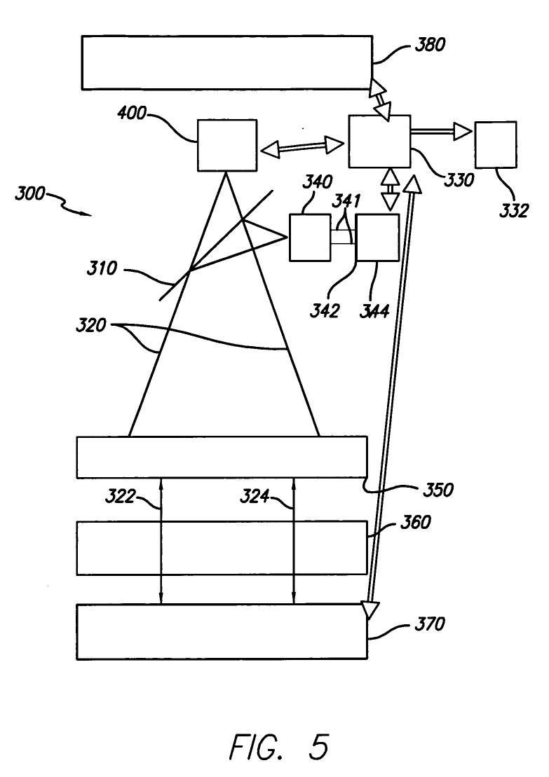

FIG. 3 is a magnified view of a portion of UUT 360 of an embodiment of the present invention. Ray 322 represents light that comes from interferometer 300 (see FIG. 5) and is shown near and within UUT 360. The arrowhead on the ray indicates the direction of propagation. A portion of the light represented by ray 322 incident on the first surface 362 will be reflected and is represented as ray 322a and is shown displaced from the incident ray 322. The displacement of ray 322a along surface 362 from ray 322 is done solely for clarity in the indication of propagation direction. In reality, ray 322a intersects surface 362 at the same location as ray 322. Ray 322a is directed towards interferometer 300. The portion of ray 322 transmitted through surface 362 continues towards the second surface 364 where a second portion of light is reflected and represented by ray 322b. Once again, ray 322b is shown displaced from where ray 322 intersects surface 364 for clarity in the indication of propagation direction. Both the first portion of light represented by ray 322a and the second portion represented by ray 322b will propagate back through the system and reach the detector 344 (see FIG. 5). The first and second portion of reflected light represented by ray 322a and ray 322b will coherently add and then be detected by detector 344. The phase between the two portions of light will be determined by the physical thickness and index of refraction of UUT 360 where ray 322 passes through it.

In the same manner as described for ray 322, ray 322a and ray 322b, a second ray 324 from interferometer 300 is directed towards UUT 360 and a portion of the light represented by ray 324 will be reflected by first surface 362 and is represented by ray 324a and a second portion will be reflected by second surface 364 and is represented by ray 324b. The ray 324 is incident on the UUT 360 in a region where the UUT 360 is thinner than in the region around ray 322. Because the physical thickness of the UUT 360 has changed, the phase between the reflected portion 324a and 324b will be different than the phase between 322a and 322b. The dependence of phase or optical path length, as a function of position on the UUT 360 results in an interference pattern 342 (see FIG. 5) on detector 344 that is directly related to the physical thickness of the UUT 360 and the local index of refraction. Since the physical thickness and local index of refraction define the transmitted wavefront, the interference pattern is a measurement of the transmitted wavefront in double pass.

One of the advantages of the invention is that the two portions of light that interfere are common path on the way to the UUT 360 and they are substantially common path on the way from the UUT 360 to the detector 344. The only region in which the two reflected wavefronts are not substantially common path is between surface 362 and surface 364 of UUT 360, where the difference between the two paths is the means by which the transmitted wavefront is measured. Since the first portion of light 322a is reflected light from ray 322 and the second portion of light 322b is also reflected light from ray 322, any wavefront errors introduced by imperfect optics or alignment errors will be identical in both portions of light. The second portion of light 322b passes through the UUT 360 twice and records the transmitted wavefront. If the UUT 360 is not perfect, the path that the second portion of light 322b takes to the detector will be slightly different than the path that the first portion of light 322a takes. This slightly different path results in what is commonly called retrace error. If the intersection location of a ray with detector 344 differs from the expected location, then a mapping error between the UUT 360 and detector 344 exists and will result in a measurement error. Mapping error is a generalization of the concept of distortion and is the difference between the expected and actual coordinates. Distortion if present, but known and corrected for would result in no mapping error. Mapping and retrace errors are a common problem in interferometers. It is known that the retrace error tends to zero as the part being tested approaches perfection. Methods for dealing with mapping and retrace errors are known in the art. If the UUT 360 is misaligned, the errors introduced in the first portion of reflected light will be substantially identical to the errors introduced in the second portion of reflected light. This is because the first surface 362 and the second surface 364 always move together. This makes the transmitted wavefront measurement substantially insensitive to misalignment.

For any UUT 360 that is of modest quality, the first portion of light 322a and the second portion of light 322b will have a substantially common path from the UUT 360 to the detector 344. Since so much of the path is common, the interferometer is substantially insensitive to misalignment and environmental changes. If one of the components is misaligned, then the errors introduced into the first and second portions of light 322a and 322b will be substantially identical and cancel in the interference pattern. This is also true if one of the optical components does not have its ideal shape. A lens with astigmatism is one example. The interferometer is also insensitive to many environmental factors. For example, normal room air turbulence will not have a significant impact on the system because the turbulence will be substantially common path.

FIG. 4 is a schematic diagram of a time-delayed source (TDS) 400. A short coherence length source 210 is connected to controller 212. Source 210 may be a superluminescent diode. Coupling means 220 directs the light from source 210 along input path 230 towards path splitting and combining device 240 shown as a cube beam splitter with beam splitting surface 242. First path 250 is directed towards first reflector assembly 260 and second path 252 is directed towards reflector assembly 262. Light incident upon either reflector assembly 260, 262 is directed back along the corresponding path to beam splitting and combining device 240. The combined light of interest is directed along path 270 to output coupling means 280 and becomes output light 290.

FIG. 4 shows a TDS 400 that is similar in form to a Michelson interferometer. The TDS 400 could also be implemented in other forms that are known in the art. Examples are the Mach-Zender, Fizeau or diffraction grating beam splitter interferometers. In addition, the reflector assemblies 260 and 262 can be implemented in a number of ways. Some examples are flat or curved mirrors could be used as well as retro-reflectors (corner cubes and cat's eye reflectors are two examples), fiber Bragg gratings or Faraday mirrors.

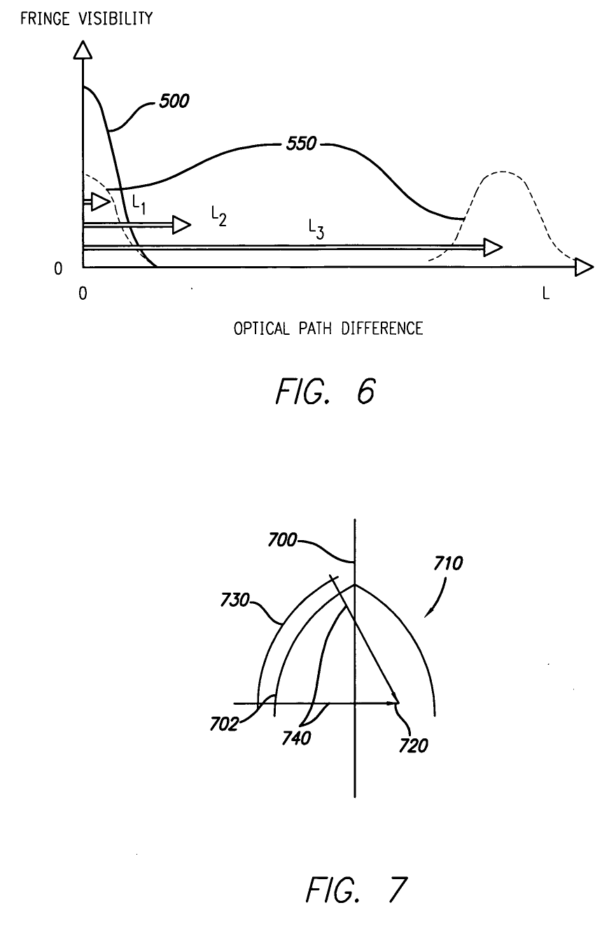

FIG. 6 is a graph representing the coherence length properties of both a short coherence length source 210 and the TDS 400 output light 290. The coherence length properties of the short coherence length source 210 by itself (i.e. without the influence of TDS 400) are represented by the solid curve 500. The coherence length of short coherence length source 210 can be measured by using it as a source for a Michelson interferometer. The maximum fringe visibility occurs when the optical path difference L between the two arms of the Michelson interferometer is zero and curve 500 is at a maximum. As the optical path difference increases, the fringe visibility decreases. A short coherence length source is one for which fringe visibility drops to a value of essentially zero for small optical path difference L. In FIG. 6, for a distance L=L₁, fringe visibility is large while for a distance L₂ fringe visibility is practically zero.

The output light 290 from TDS 400 includes light from short coherence length source 210 that has traversed two different paths with lengths that are not necessarily equal. If the coherence length properties of output light 290 from TDS 400 are measured by using it as a source for a Michelson interferometer, then the dotted curve 550 is produced with a maximum fringe visibility for a distance L equal zero about one-half the maximum of the short coherence length source 210 by itself. Similarly, for a distance L₂, the fringe visibility is zero. However, for a distance L₃ that is equal to the optical path length difference between the first path 250 and second path 252, the fringe visibility reaches a second maximum. In other words, this source has two localized regions of coherence that are at substantially different optical paths differences. As long as optical path difference L is varied a small amount about the value L₃, substantial fringe visibility will result. Since this distance, L₃, determines the optical path difference at which the fringe contrast is maximum, it is referred to as the delay length of TDS 400. L₃ is set, in practice, to substantially match the optical path difference between the reflections from the first surface 362 and second surface 364 of UUT 360. This configuration is desirable because there will be coherence between light reflected from two different surfaces if the optical path length between them is approximately one half of L₃. The coherence length of the source will determine how the coherence changes as the distance is varied, but it is possible to isolate the surfaces being tested by selecting an appropriate source and matching the path in the TDS 400. This is valuable when testing multi-layer systems.

FIG. 4 shows TDS 400 as a free space assembly, but TDS 400 may easily be made using fiber optic (e.g., optical fiber) or integrated optic components or a combination of any or all of these types of components. For instance, coupling means 220 may be a free space to fiber optic coupler. Alternatively, source 210 and coupling means 220 might even be in a single, hermetically sealed package. In either case, any combination of input path 230, first path 250, second path 252 and output path 270 may be implemented in free space, fiber optics or integrated optics. Similarly, path splitting and combining device 240 may be a cube beam splitter, two-by-two fiber optic coupler or an integrated optical component. Similarly, either one or both first path reflector assembly 260 and second path reflector assembly 262 may include means to adjust the path length difference to match a particular UUT 360. Additionally, the path matching means may be used to modulate the phase of the interference pattern for phase shifting algorithms as known in the art.

In one embodiment of TDS 400, source 210 is fiber coupled and a two-by-two fiber optic coupler is used for path splitting and combining device 240. First path 250 and second path 252 would be made of fiber optic cable. One or both reflector assemblies 260 and 262 can incorporate a means to stretch a coil of fiber optic for paths 250 and 252, respectively. Stretching the fiber optic stretches the optical paths and can be used for path matching or phase modulation or both. One embodiment is to optimize the implementation of one path, (either first path 250 or second path 252) for optical path matching of UUT 360 and the other path for phase modulation since the range of motions are substantially different.

If output path 270 of the TDS 400 is implemented in single mode fiber than the two, time-delayed sources will both be certain to be at the same location. A fiber optic cable and connector can be thought of as a low-pass spatial filter. If the TDS 400 is implemented using free space components, then it is advantageous to incorporate a low-pass spatial filter in out-put coupling device 280 to ensure that both time-delayed sources are coincident so that an accurate measurement of tilt between the first surface 362 and second surface 364 of UUT 360 can be obtained.

FIG. 5 is a diagram of interferometer system 300 for measurement of UUT 360. The TDS 400 is the source for interferometer 300 and may optionally be controlled by computer 330. Light from TDS 400 is directed towards beam splitter 310. Light may traverse path 320 to optional wavefront matching optics 350. Wavefront matching optics 350 may, for example, be used to change the numerical aperture of the wavefront to better match UUT 360. Light is incident upon UUT 360 and represented by rays 322 and 324 and reflections from both surfaces of UUT 360 are returned substantially along the same path towards optional wavefront matching optics 350. The light is then directed towards beam splitter 310, which directs a portion of the light towards imaging optics 340. Light exiting from imaging optics 340 forms an interferogram 342 of the transmitted wavefront of UUT 360 on detector 344. Computer 330 acquires data from the detector 344 while controlling TDS 400 so as to modulate the phase of the interference pattern in a coordinated manner so as to calculate measurement results 332 for use as desired, such as in deterministic fabrication methods.

Also included in FIG. 5 is optional mechanism 370 for moving the UUT 360 relative to interferometer system 300 and optional mechanism 380 for moving the interferometer system 300 relative to UUT 360. Both optional mechanisms 370, 380, if present, are controlled by computer 330 for the purpose of acquiring sub-aperture data for stitching. In an embodiment, the optional mechanisms 370, 380 are used to change the relative orientation between the interferometer 300 and the UUT 360. The transmitted wavefront of a sub-aperture is measured and stored. The relative position of the interferometer 300 and UUT 360 is changed and the transmitted wavefront of a second sub-aperture is then measured. The process is repeated until sub-aperture measurements covering the desired portion of the UUT are obtained. The sub-aperture measurements are then assembled (“stitched”) to form a single measurement of the transmitted wavefront over the desired portion of the UUT 60. The data produced with each interference pattern can be stitched together to form a continuous transmitted wavefront measurement for a region of the UUT 360 that is larger than any single sub-aperture measurement. In this embodiment, continuous transmitted wavefront measurement of the UUT 360 covers substantially all of the UUT's 360 clear aperture.

If an optional scanning mechanism 370, 380 is present, it is preferably designed so as to take advantage of symmetry present in UUT 360. For instance, FIG. 7 shows a tangent ogive 710, which is a conformal shape produced by rotating a circular arc 702 whose center of curvature 720 is about an axis of rotation 700 that does not intersect the center of curvature 720. Converging wavefront 730 is shown with its axis proximate to the center of curvature 720 of a circular arc 702 representing a cross-section of tangent ogive 710. A hemisphere is a degenerate case of a tangent ogive 710 produced by rotating a quarter of a circle about a line through the center of curvature of the circular arc.

Sub-aperture measurements of a spherical or a tangent ogive dome can be effectively acquired by using a rotary stage for optional scanning mechanism 370. The axis of revolution of UUT 360 is aligned to the axis of rotation of optional scanning mechanism 370. A wavefront matching optic 350 may be used to produce a converging spherical wavefront 730. If UUT 360 is a spherical dome, then the center of curvature 720 of the spherical wavefront 730 should be aligned to the center of curvature of the dome. If the UUT 360 is an ogive, then the center of curvature 720 of the spherical wavefront 730 should be aligned to the center of curvature of the circular arc 702 that is used to create the ogive.

If UUT 360 is a spherical dome, then the sub-aperture that can be measured would be a circular patch, while if UUT 360 is a tangent ogive, then the sub-aperture that can be measured would be a vertical strip that is wider at the base than the tip. A cylindrical window lends itself to being scanned with a linear motion. A window with different radii of curvature in different directions lends itself to being scanned with an angular motion. A free-form optic might require more generalized scanning. In all cases though, the reduced alignment sensitivity reduces the demands on the scanning system to obtain useful measurements of the transmitted wavefront. Additionally, since there is no reference surface in interferometer 300, it is not necessary to calibrate the reference surface or account for it in when stitching sub-aperture data.

A TDS 400 can be implemented for any wavelength with available suitable components. If a wavelength is used that is not visible, it is often possible to mix a visible wave-length with the source to simplify test setup.

The reflector assembly 260, 262 can be used to scan through the volume of UUT 360 and to acquire data from other interfaces within the UUT, not just the outer surfaces of the UUT. All that is required is to incorporate sufficient precision in the mechanism to make the data useful.

Although the description of the present invention has referred to dome-like optics, the present invention is directly applicable to the testing of a variety of other optics including conformal windows and domes. The benefits described for both measurement of an aperture as well as scanning combined with measurements of sub-apertures all apply. The only restriction on the shape of a UUT is that the patch of a UUT measured in any particular setup produces an interference pattern that can be acquired. If the UUT is substantially constant thickness then the transmitted wavefront error from a portion of the UUT may be obtained from the interference pattern over the UUT patch with sufficient accuracy without considering mapping or retrace errors. Alternatively, a non-constant thickness patch of a UUT may be measured if algorithms that account for mapping and retrace errors are incorporated into the software for processing of the acquired data. The present invention can be used to measure the transmitted wavefront of optics including concentric spherical shells or plane parallel windows, conformal domes or conformal windows and even free-form optics in combination with appropriate wavefront matching optics, scanning mechanisms and software, or both.

Thus, there has been disclosed a time-delayed source and interferometric measurement of windows and domes. It will be readily apparent to those skilled in this art that various changes and modifications of an obvious nature may be made, and all such changes and modifications are considered to fall within the scope of the present invention, as defined by the appended claims.

What is claimed is:

1. An interferometer comprising a time-delayed source, light emitted from the time-delayed source, support for a unit under test where the unit under test has a first surface and a second surface, and a detector where the light emitted from the time-delayed source has a delay length and a first portion of said light is reflected off the first surface of the unit under test and a second portion of said light is reflected off of the second surface of the unit under test and a portion of the two reflected portions of light are incident on the detector where the light coherently adds which forms an interference pattern that is detected by said detector.

2. An interferometer of claim 1 where the delay length of the time-delayed source substantially matches twice the optical path length between the first surface and the second surface of the unit under test.

3. An interferometer of claim 1 where the source of light in the time-delayed source is a superluminescent diode.

4. An interferometer of claim 1 where the light from the source in the time-delayed source is coupled into optical fiber.

5. An interferometer of claim 1 where the time-delayed source further comprises a beam splitter where said beam splitter is one of a plate beam splitter, cube beam splitter or a two-by-two fiber coupler.

6. An interferometer of claim 1 where the time-delayed source further comprises a first path and a second path.

7. An interferometer of claim 6 where the delay length can be adjusted in either the first path or the second path of the time-delayed source.

8. An interferometer of claim 6 where at least one or both of the first path and the second path further comprises a fiber optic.

9. An interferometer of claim 8 where the phase is modulated by stretching the fiber optic in either the first path or the second path of the time-delayed source.

10. An interferometer of claim 7 where the delay length can be adjusted in both the first path and the second path of the time-delayed source.

11. An interferometer of claim 7 where the delay length can be modulated.

12. An interferometer of claim 9 where the delay length can be adjusted in either the first path or the second path and modulated in the other path.

13. An interferometer of claim 6 where each path further comprises a reflector assembly.

14. An interferometer of claim 13 where the reflector assembly comprises either a flat mirror or a curved mirror.

15. An interferometer of claim 13 where the reflector assembly comprises a retro reflector, a fiber Bragg grating, or a Faraday mirror.

16. An interferometer of claim 1 where the time-delayed source further comprises a spatial filter.

17. An interferometer of claim 16 where the spatial filter is a low pass spatial filter.

18. An interferometer of claim 17 where the low pass spatial filter comprises either a pinhole or a fiber optic.

19. An interferometer of claim 1 where the interferometer further comprises a computing means.

20. An interferometer of claim 19 where the computing means is used to perform phase shifting interferometry.

21. An interferometer of claim 19 where the computing means is used to correct for mapping error.

22. An interferometer of claim 19 where the computing means is used to correct for retrace error.

23. An interferometer of claim 1 where the interference pattern is representative of the transmitted wavefront for a portion of the unit under test.

24. An interferometer of claim 19 further comprising a scanning means.

25. An interferometer of claim 24 where the scanning means moves the support of the unit under test.

26. An interferometer of claim 24 where the scanning means moves the interferometer.

27. An interferometer of claim 24 where the scanning is at least one of spatial and angular.

28. An interferometer of claim 24 where the scanning means allows for the collection of interference patterns that represent substantially an entire aperture of the unit under test.

29. An interferometer of claim 24 where the computing means assembles a single representation of the surface from measurements of one or more sub-apertures.

30. An interferometer of claim 1 further including the unit under test.

31. An interferometer of claim 30 where the interference pattern is representative of the transmitted wavefront of the unit under test.

32. An interferometer of claim 30 where the unit under test is a concentric spherical shell.

33. An interferometer of claim 30 where the unit under test is a window.

34. An interferometer of claim 30 where the unit under test is a substantially constant thickness optic.

35. An interferometer of claim 30 where the unit under test is a substantially non-constant thickness optic.

36. An interferometer of claim 30 where the unit under test is a conformal dome or window.

37. An interferometer of claim 36 where the unit under test is an ogive.

38. An interferometer of claim 37 where the ogive is a tangent ogive.

39. An interferometer of claim 36 where the conformal window has different radii of curvature in different directions.

40. An interferometer of claim 39 where the conformal window is cylindrical.

41. A method for measuring the transmitted wavefront over the desired aperture of a unit under test, comprising:
providing an interferometer comprising a time-delayed source, light emitted from the time-delayed source, support for a unit under test where the unit under test has a first surface and a second surface, and a detector where the light emitted from the time-delayed source has a delay length and a first portion of said light is reflected off the first surface of the unit under test and a second portion of said light is reflected off of the second surface of the unit under test and a portion of the two reflected portions of light are incident on the detector where the light coherently adds which forms an interference pattern that is detected by said detector;
supporting the unit under test in the interferometer;
measuring the transmitted wavefront of a first sub-aperture of the unit under test;
changing the relative position of the interferometer and unit under test;
measuring the transmitted wavefront of a second sub-aperture of the unit under test;
repeating the measurements for the desired portion of the unit under test; and
assembling the measurements into a single measurement of the desired aperture of the unit under test.
